(19) United States
(12) Patent Application Publication
(10) Pub. No.: US 2026/0054729 A1
(43) Pub. Date: Feb. 26, 2026

(54) APPARATUSES, METHODS, AND SYSTEMS INCLUDING HYBRID POWERTRAINS WITH POSITIVE CLUTCHES

(71) Applicant: Cummins Inc., Columbus, IN (US)

(72) Inventors: David B. Snyder, Greenwood, IN (US); Andrew W. Osburn, Nashville, IN (US); Adam C. Cecil, Columbus, IN (US); Anant Puri, Greenwood, IN (US); Ming-Feng Hsieh, Nashville, IN (US); Timothy Shipp, Seymour, IN (US)

(21) Appl. No.: 19/103,691

(22) PCT Filed: Aug. 16, 2023
(86) PCT No.: PCT/US2023/072297

§ 371 Date: Feb. 13, 2025

Related U.S. Application Data
(60) Provisional application No. 63/373,372, filed on Aug. 24, 2022.

(51) Int. Cl. B60W 30/18; B60K 6/387; B60K 6/48; B60W 10/02; B60W 10/08

(52) U.S. Cl. CPC B60W 30/18027; B60K 6/387; B60K 6/48; B60W 10/02; B60W 10/08; B60K 2006/4825; B60W 2510/081

(57) ABSTRACT

A vehicle includes a hybrid powertrain and a positive clutch. The hybrid powertrain includes an engine and a motor/generator that are controlled so that the positive clutch can be effectively employed in the hybrid powertrain during vehicle launch, gear shifting, engine starting, and transitioning between propulsion modes.

### CROSS-REFERENCE TO RELATED APPLICATION

The present applications claims priority to, and the benefit of the filing date of, U.S. Provisional Application Ser. No. 63/373,372 filed Aug. 24, 2022, which is incorporated herein by reference.

### TECHNICAL FIELD

The present disclosure relates to apparatuses, methods, and systems including hybrid powertrains with a positive clutch.

### BACKGROUND

Friction type clutches have been widely employed for connecting an internal combustion engine to a drivetrain such as during engine starting and gear changes. This is because friction type clutches allow controlled slippage between the output shaft of the engine and the drivetrain. As a result, vehicle launch from a stopped position or after a gear change can be completed smoothly using friction type clutches by controlling the allowed slippage between the engine and drivetrain as the engine speed is synchronized to the drivetrain speed. However, friction type clutches are complex, expensive, and occupy a relatively large footprint in the powertrain architecture. Therefore, there remains a significant unmet need for the unique apparatuses, methods, and systems disclosed herein.

### DISCLOSURE OF EXAMPLE EMBODIMENTS

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created and that the invention includes and protects such alterations, modifications, and further applications of the example embodiments as would occur to one skilled in the art.

### SUMMARY OF THE DISCLOSURE

Example embodiments include unique apparatuses, methods, and systems including hybrid powertrains with a positive clutch to engage the output shaft of the internal combustion engine to an input shaft of the drivetrain. In an embodiment, the hybrid powertrain and the positive clutch are controlled for starting the engine. In an embodiment, the hybrid powertrain and positive clutch are controlled for a gear change of a transmission. In an embodiment, the hybrid powertrain and positive clutch are controlled for launching a vehicle. In an embodiment, the hybrid powertrain and positive clutch are controlled for transitioning between propulsion modes of the hybrid powertrain. Further embodiments, forms, objects, features, advantages, aspects, and benefits shall become apparent from the following description and drawings.

### BRIEF DESCRIPTION OF THE DRAWINGS

FIG. 1 is a schematic diagram illustrating certain aspects of an example vehicle including a powertrain with a positive clutch.

FIG. 2 is a flowchart illustrating certain aspects of an example control method for vehicle launch of the vehicle of FIG. 1.

FIG. 3 is a flowchart illustrating certain aspects of another example control method for vehicle launch of the vehicle of FIG. 1.

FIG. 4 is a flowchart illustrating certain aspects of another example control method for vehicle launch of the vehicle of FIG. 1.

FIG. 5 is a flowchart illustrating certain aspects of another example control method for a gear change of the vehicle of FIG. 1.

FIG. 6 is a flowchart illustrating certain aspects of another example control method for a transition between modes of propulsion of the vehicle of FIG. 1.

FIG. 7 is a flowchart illustrating certain aspects of another example control method for a transition between modes of propulsion of the vehicle of FIG. 1.

FIG. 8 is a flowchart illustrating certain aspects of another example control method for starting the engine of a stationary vehicle of FIG. 1.

FIG. 9 is a flowchart illustrating certain aspects of another example control method for starting the engine of a stationary vehicle of FIG. 1.

### DETAILED DESCRIPTION OF EXAMPLE EMBODIMENTS

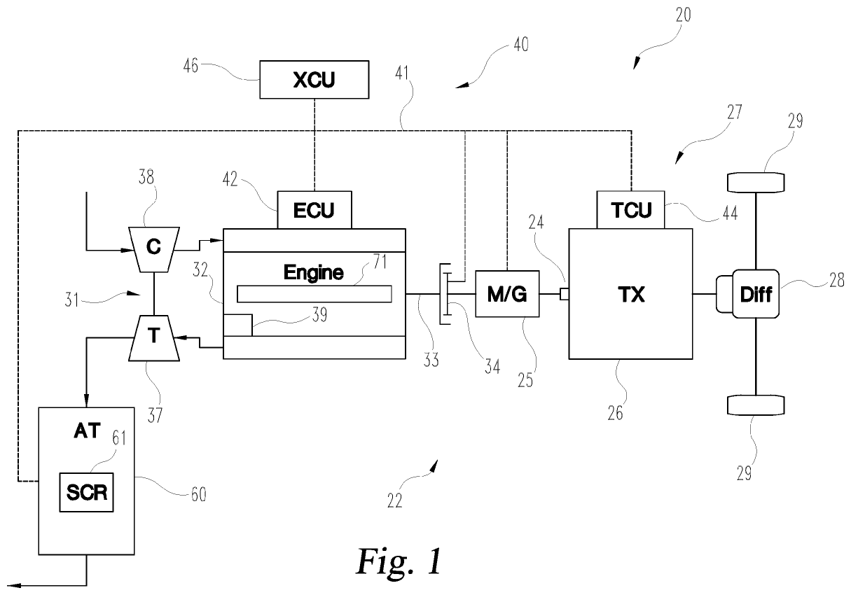

With reference to FIG. 1, there is illustrated an example vehicle 20. In the illustrated embodiment, vehicle 20 includes a powertrain 22 including an internal combustion engine 32, an output shaft 33, a positive clutch 34, a motor/generator 25, and a drivetrain 27. Drivetrain 27 may include a transmission 26, a differential 28, and ground engaging wheels 29. In the illustrated embodiment, vehicle 20 is propelled by ground engaging wheels 29, which are configured and provided as rear wheels. In other embodiments, front-wheel drive, four-wheel drive, and all-wheel drive approaches are contemplated. In various embodiments, vehicle 20 may be configured and provided as an on-road bus, delivery truck, a service truck, passenger truck, passenger car, or the like. In other aspects, vehicle 20 may be configured and provided as a different type of vehicle, including other types of on-road or off-road vehicles.

In the illustrated embodiment, the powertrain 22 includes internal combustion engine 32 operatively coupled with and configured to provide torque to output shaft 33. In some embodiments, output shaft 33 may be configured and provided as a flywheel and/or a crankshaft. A first side of positive clutch 34 is operatively coupled with and configured to provide torque to (or receive torque from) output shaft 33 and, in turn, engine 32. A second side of positive clutch 34 is operatively coupled with and configured to provide torque to (or receive torque from) motor/generator 25 and, in turn, an input shaft 24 of the transmission 26 and, in turn, to other components of the powertrain 22 which may be coupled therewith.

Positive clutch 34 is electronically controllable between a closed state and an open state. In the closed state, torque applied to the first side of positive clutch 34 is transferred to the second side of positive clutch 34 and vice-versa. In the open state, torque is not transferred between the first side and the second side of positive clutch 34, for example, due to a gap or separation between clutch components. As used herein, a positive clutch 34 is a non-slipping clutch in which the first and second sides of the clutch are configured to interlock with one another in the closed position with no slippage between the first and second side. Examples of positive clutches include dog clutches, spine clutches, jaw clutches, claw clutches, and the like.

Motor/generator 25 is configured and provided in the form of a traction motor, which is separate and distinct from an optional starter motor 39, which is coupled with and dedicated to starting the engine 32 under some conditions. In some embodiments, starter motor 39 may be omitted from vehicle 20. Motor/generator 25 is operable as a motor to output torque to input shaft 24 of transmission 26 to propel the vehicle. Such operation may occur with positive clutch 34 being open such that only motor/generator 25 is used to propel the vehicle. Such operation may also occur with positive clutch 34 being closed such that motor/generator 25 propels the engine in combination with engine 32, or with engine 32 propelling vehicle 20 through motor/generator 25 while generating electrical energy with motor/generator 25. Motor/generator 25 is further operable as a generator to receive torque from input shaft 24 of transmission 26, for example, during regenerative braking operation. Motor/generator 25 is further operable as a motor to drive engine 32 via positive clutch 34, for example, during engine restart operations.

In the illustrated embodiment, the powertrain 22 is configured and provided as a parallel hybrid combustion engine-electric powertrain system. In other embodiments, the powertrain 22 may be provided in other forms of a hybrid combustion engine-electric powertrain system. In the illustrated embodiment, the powertrain 22 is configured and provided with positive clutch 34 being coupled with and positioned between engine 32 and motor/generator 25. In other embodiments, positive clutch 34 may be coupled with and positioned between engine 32 and motor/generator 25 and another clutch may be coupled with and positioned between motor/generator 25 and input shaft 24 of transmission 26.

Transmission 26 may be configured and provided in a number of forms. In some forms, transmission 26 may be configured and provided as a manual transmission including a gearbox and an operator-actuated internal clutch. In some forms, transmission 26 may be configured and provided as an automated manual transmission including a gearbox and an internal clutch that may be automatically actuated or actuated in response to operator input. In some forms, transmission 26 may be configured and provided as an automatic transmission including a planetary gear set. In some forms, transmission 26 may be configured and provided as continuously variable transmission.

In the illustrated embodiment, engine 32 is configured as a turbocharged, compression-ignition diesel engine including a cylinder decompression system 71. It shall be appreciated that engine 32 may be provided as another type of engine in other embodiments. Powertrain 22 may be provided with a turbocharger 31 including a turbine 37 and a compressor 38. Turbine 37 extracts energy from the exhaust gas from engine 32 to drive compressor 38 to compress charge air flow to engine 32. In other embodiments, powertrain 22 may be provided with torque from additional components such as an electric motor operatively coupled with a battery or other energy storage system, one or more vehicle accessories or other power providing component.

Cylinder decompression system 71 may be provided in a number of forms that are configured and operable to reduce cylinder pressure during a compression stroke of engine 32 relative to the cylinder pressure that would otherwise result from the compression stroke. In some forms, cylinder decompression system 71 may be configured and provided as a cylinder deactivation (CDA) system. In some forms, cylinder decompression system 71 may be configured and provided as a compression release braking system. In some such forms, a hydraulic or electric actuator may be provided in a valvetrain between a valve of engine 32 and a valve cam of engine 32 and may be electronically controlled to vary the response of the valve to the valve cam. For example, such an actuator may be provided to selectably maintain an exhaust valve and/or intake valve open and/or closed during at least a part of the piston stroke of the engine 32.

In the illustrated embodiment, vehicle 20 may include an exhaust aftertreatment system 60 provided downstream of engine 32 that injects a liquid-reductant agent through a special catalyst into the exhaust stream of a diesel engine. The exhaust aftertreatment system 60 may include a selective catalyst reduction (SCR) catalyst 61 configured to inject a liquid-reductant agent into the exhaust stream.

The vehicle 20 includes an electronic control system (ECS) 40 that includes a plurality of control components and structures. ECS 40 may include one or more programmable microprocessors or microcontrollers of a solid-state, integrated circuit type that are provided in one or more constituent control units of ECS 40. It is also contemplated that ECS 40 may include other types of integrated circuits and/or discrete circuit control units. In the illustrated embodiment, ECS 40 includes an engine control unit (ECU) 42, a transmission control unit (TCU) 44, and may include one or more additional control units (XCU) 46. ECU 42, TCU 44, and XCU 46 (where present) are operatively coupled with and configured for communication over a network 41 which may be configured as a controller area network (CAN) or another type of network providing communication capabilities. ECS 40 is also operatively coupled with various components and systems of the vehicle system 20 via network 41 or one or more additional or alternative networks.

ECS 40 can be implemented in a number of configurations that combine or distribute control components, functions, or processes across one or more control units in various manners. ECS 40 executes operating logic that defines various control, management, and/or regulation functions. This operating logic may be in the form of dedicated hardware, such as a hardwired state machine, analog calculating machine, programming instructions, and/or a different form as would occur to those skilled in the art. ECS 40 may be provided as a single component or a collection of operatively coupled components; and may be comprised of digital circuitry, analog circuitry, or a hybrid combination of both of these types. When of a multi-component form, ECS 40 may have one or more components remotely located relative to the others in a distributed arrangement. ECS 40 can include multiple processing units arranged to operate independently, in a pipeline processing arrangement, in a parallel processing arrangement, or the like. It shall be further appreciated that ECS 40 and/or any of its constituent components may include one or more signal conditioners, modulators, demodulators, Arithmetic Logic Units (ALUs), Central Processing Units (CPUs), limiters, oscillators, control clocks, amplifiers, signal conditioners, filters, format converters, communication ports, clamps, delay devices, memory devices, Analog to Digital (A/D) converters, Digital to Analog (D/A) converters, and/or different circuitry or components as would occur to those skilled in the art to perform the desired communications.

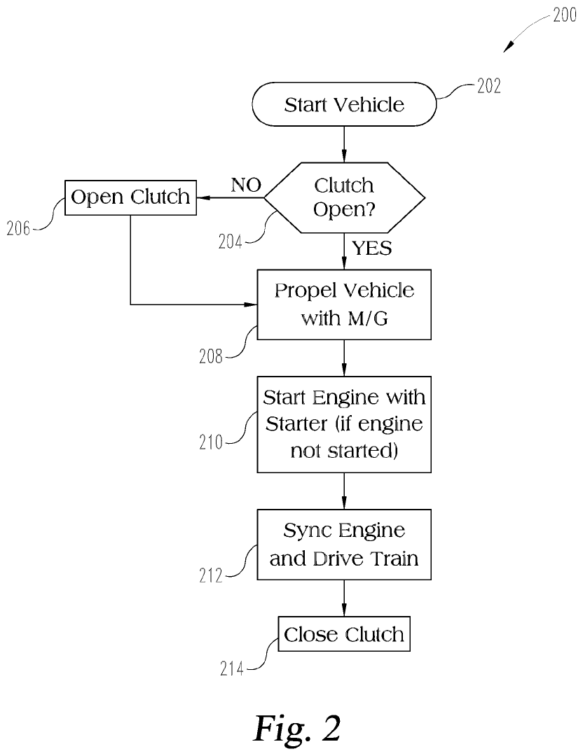

With reference to FIGS. 2-5, there are illustrated example methods which may be implemented and performed by operating an electronic control system such as ECS 40 or another electronic control system operatively coupled with a vehicle system (e.g., vehicle 20 or another vehicle system) including an engine (e.g., engine 32 or another engine). When implemented and performed by ECS 40, the methods may be performed, in whole or in part, by ECU 42, TCU 44, XCU 46, other components of ECS 40, or by combinations of such components.

For example, in FIG. 2 a method 200 is initiated at operation 202 to receive a command or input to start the vehicle 20, such as for a vehicle launch from a stopped position. The operation 202 may consider, for example, the key on/off state of the vehicle 20, the engine 32 on/off operating state, accelerator pedal position, brake pedal position, or other indicators of a vehicle launch during vehicle operation. From start operation 202, method 200 proceeds to conditional 204, which evaluates whether positive clutch 34 is open. If conditional 204 evaluates negative, method 200 continues at operation 206 to open positive clutch 34. If conditional 204 is affirmative, or after completing operation 206, method 200 continues at operation 208 to propel vehicle 20 for launch with power from motor/generator 25 alone while the motor/generator 25 disengaged from engine 32.

After operation 208, engine 32 can be started at operation 210, if engine 32 is not already started. For example, starter motor 39 can be used to start rotation of engine 32 for starting while positive clutch 34 is open. Method 200 continues at operation 212 to control the speed of the started engine 32 and drivetrain 27 to obtain a synchronization speed. For example, the speed of output shaft 33 can be synchronized within a predetermined threshold of the speed of input shaft 24 and/or the speed of motor/generator 25. In an embodiment, ECS 40 controls the speed of engine 32 and motor/generator 25 so that the speeds are synchronized within an allowable threshold of one another.

Method 200 continues at operation 214 to close positive clutch 34 after the synchronization speeds of engine 32 and powertrain 27 are obtained, or are reached within an allowable threshold difference. Preferably, the allowable threshold difference in the speeds of engine 32 and drivetrain 27 required to close positive clutch 34 provides an acceptable level of smoothness during the transition while minimizing wear and damage on positive clutch 34. Once positive clutch 34 is closed, engine 32 and/or motor/generator 25 can be used to propel vehicle 20 depending on the state of battery charge, torque demand, and/or other power division parameters among the components of powertrain 22.

Operation 210 may include accelerating the engine 32 of the vehicle 20 toward a synchronization speed with motor/generator 25 to engage positive clutch 34. As utilized herein, the term synchronization speed refers to an engine speed that is at idle speed or greater than an idle speed of the engine 32. It shall be appreciated that the idle speed of the engine 32 may be different in various embodiments including different types of engines. For example, some engines may have idle speeds of 300 rpm or potentially lower. Other engines may have idle speeds of 1200 rpm or potentially higher. Some engines may have idle speeds in the range of 500 rpm to 800 rpm. It shall be further appreciated that the engine idle speed may be dynamically varied during engine operation, for example, the engine idle speed may be increased during engine warm-up operation and reduced once the engine is warm.

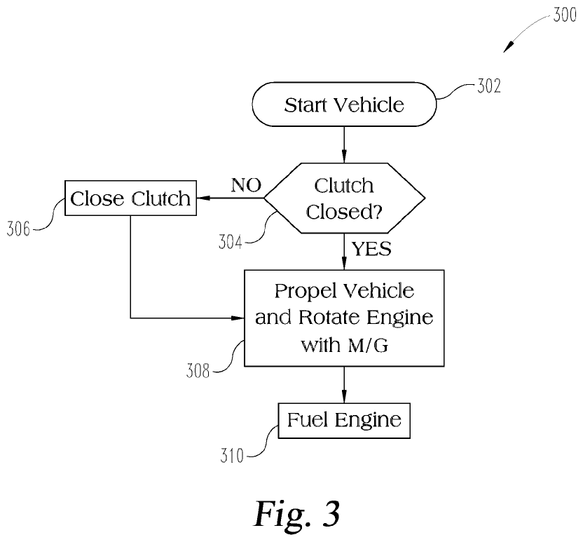

Another embodiment method 300 for starting vehicle 20 is discussed with reference to FIG. 3. Method 300 is initiated at operation 302 to receive a command or input to start the vehicle 20, such as for a vehicle launch from a stopped position. The operation 302 may consider, for example, the key on/off state of the vehicle 20, the engine 32 on/off operating state, accelerator pedal position, brake pedal position, or other indicators of a vehicle launch during vehicle operation. From start operation 302, method 300 proceeds to conditional 304, which evaluates whether positive clutch 34 is closed. If conditional 304 evaluates negative, method 300 continues at operation 306 to close positive clutch 34.

If conditional 304 is affirmative, or after completing operation 306, method 300 continues at operation 308 to propel vehicle 20 for launch with power from motor/generator 25 alone while the motor/generator 25 is engaged to engine 32 with positive clutch 34. Operation 308 also includes rotating engine 32 with motor/generator 25 since positive clutch 34 is closed. Method 300 continues at operation 310 to fuel the rotating engine 32 to allow engine 32 to be started. For example, the speed of engine 32 can be accelerated with motor/generator 25 until a threshold starting speed for engine 32 is reached, at which time fueling is initiated. Once engine 32 is started, engine 32 and/or motor/generator 25 can be used to propel vehicle 20 depending on the state of battery charge, torque demand, and/or other power division parameters among the powertrain components.

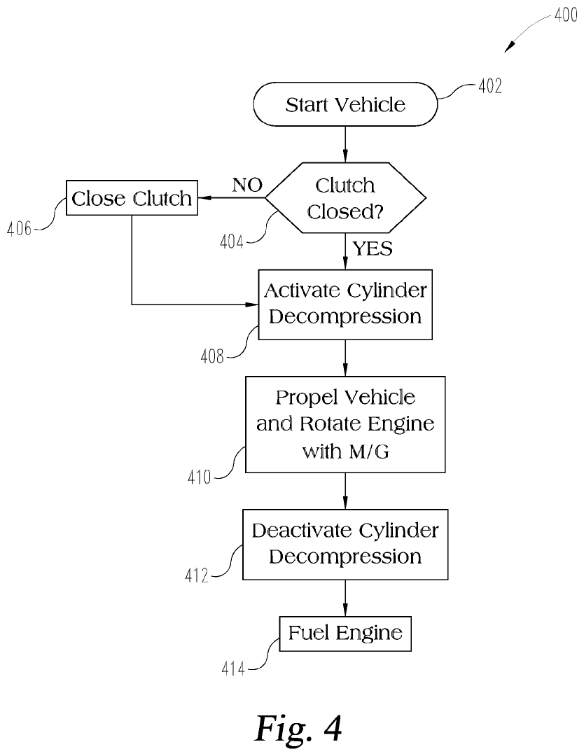

Another embodiment method 400 for starting vehicle 20 is discussed with reference to FIG. 4. Method 400 is initiated at operation 402 to receive a command or input to start the vehicle 20, such as for a vehicle launch from a stopped position. The operation 402 may consider, for example, the key on/off state of the vehicle 20, the engine 32 on/off operating state, accelerator pedal position, brake pedal position, or other indicators of a vehicle launch during vehicle operation.

From start operation 402, method 400 proceeds to conditional 404, which evaluates whether positive clutch 34 is closed. If conditional 404 evaluates negative, method 400 continues at operation 406 to close positive clutch 34. If conditional 404 is affirmative, or after completing operation 406, method 400 continues at operation 408 to active cylinder decompression, such as by activating cylinder decompression system 71. This reduces the amount of motoring torque required from motor/generator 25 to rotate engine 32.

Method 400 continues at operation 410 to propel vehicle 20 for launch with power from motor/generator 25 alone while the motor/generator 25 is engaged to engine 32 with positive clutch 34. Also, engine 32 is rotated with motor/generator 25 at operation 410 since positive clutch 34 is closed. Once engine 32 rotation starts, the cylinder decompression system 71 can be deactivated at operation 412. Method 400 continues at operation 414 to fuel the engine 32 to allow engine 32 to be started. For example, the speed of engine 32 can be accelerated with motor/generator 25 until a threshold starting speed for engine 32 is reached and the cylinder decompression system 71 is deactivated, at which time fueling to engine 32 is initiated. Once engine 32 is started, engine 32 and/or motor/generator 25 can be used to propel vehicle 20 depending on the state of battery charge, torque demand, and/or other power division parameters among the powertrain components.

Operation 412 resumes operation of the engine 32 with deactivation of the cylinder decompression system 71 based on or in response to the engine starting conditions being evaluated affirmative and thereafter restarting fueling of the engine 32. In some embodiments, the act of deactivating the cylinder decompression system 71 is performed in response to a speed of the engine 32 reaching or exceeding a speed threshold corresponding to the engine starting speed. In some such embodiments, the speed threshold may be a fixed or predetermined value that may be set to the engine starting speed or set relative to the starting speed such as a value offset from or within a threshold of the engine starting speed. In some such embodiments, the speed threshold may be dynamically determined. In some such embodiments, the speed threshold may be dynamically determined in response to a speed of a transmission input shaft speed such as transmission input shaft 24 or an input shaft of another transmission.

In some embodiments, the act of deactivating the cylinder decompression system 71 is performed in response to a state of vehicle clutch engagement. For example, in embodiments where the engine is accelerated toward a starting speed in whole or in part by closing positive clutch 34, a closed position of positive clutch 34 in combination with a non-started condition of engine 32 may be utilized as a basis for deactivating cylinder decompression.

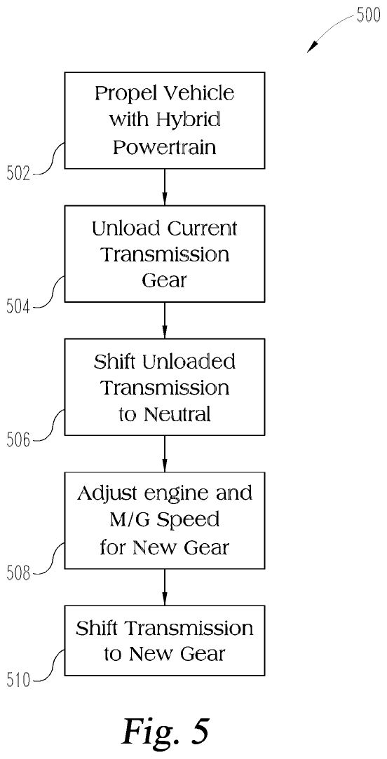

Referring to FIG. 5, a method 500 is discussed for controlling hybrid powertrain 22 during shifting of gears in transmission 26 by using “clutchless” shifting in which positive clutch 34 is not opened or actuated during gear shifting. Method 500 includes an operation 502 for propelling vehicle 20 with hybrid powertrain 22. Vehicle 20 can be propelled with engine 32, motor/generator 25, or a combination of engine 32 and motor/generator 25 according to the power division parameters of powertrain 22.

Method 500 continues at operation 504 to unload the current transmission gear in response to a request for a gear shift, such as from the driver or ECS 40. In an embodiment, the engine 32 and motor/generator 25 are ramped to a net zero torque at operation 504 to unload the current transmission gear. Method 500 continues at operation 506 to shift the unloaded transmission 26 to a neutral gear.

Method 500 continues at operation 508 to adjust the speed of the engine 32 and motor/generator 25 of hybrid powertrain 22 for the new gear. For example, the engine torque and motor/generator speed are controlled to accelerate or decelerate the engine 32 and motor/generator 25 to a new speed that is required for the desired transmission gear.

Method 500 continues at operation 510 to shift transmission from the neutral gear to the new transmission gear after operation 508. The output of engine 32 and/or motor/generator 25 can then be increased or decreased in order to meet the drive demand torque in the new gear. If additional gear changes are required, method 500 can be repeated as discussed above to shift transmission 26 to the desired new gear.

Method 500 allows “clutchless” shifting to occur since positive clutch 34 remains closed throughout the gear change. The motor/generator 25 allows negative or positive torque to be applied very quickly for unloading the current gear and to accelerate or decelerate the engine 32 for shifting into the new gear. In addition, fuel economy benefits can be realized using “clutchless” shifting since energy loss due to clutch slipping is eliminated. In addition, during upshifts, inertia from engine 32 can be recovered by operating motor/generator 25 in a generator mode.

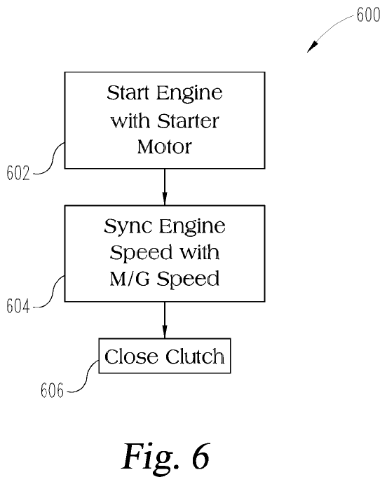

Another embodiment method 600 for starting vehicle 20 is discussed with reference to FIG. 6. Method 600 is related to transitioning vehicle 20 from a first powertrain mode to a second powertrain mode. For example, the first powertrain mode can be motor/generator 25 providing the sole means of propulsion, such as an electric vehicle powertrain mode where engine 32 is stopped. The second powertrain mode can be engine 32 providing some or all of the power for propulsion of vehicle 20, such as a parallel hybrid powertrain mode.

Method 600 begins, while vehicle 20 is operating in the first powertrain mode, at operation 602. The operation 602 includes starting engine 32 with a starter motor 39. Engine 32 can then be fueled to allow engine speed control. From engine start operation 602, method 600 proceeds at operation 604, which syncs the speed of engine 32 with the speed of motor/generator 25. After the speeds are synced, procedure 600 continues at operation 606 to close positive clutch 34, allowing the powertrain to operate in a parallel hybrid mode of operation.

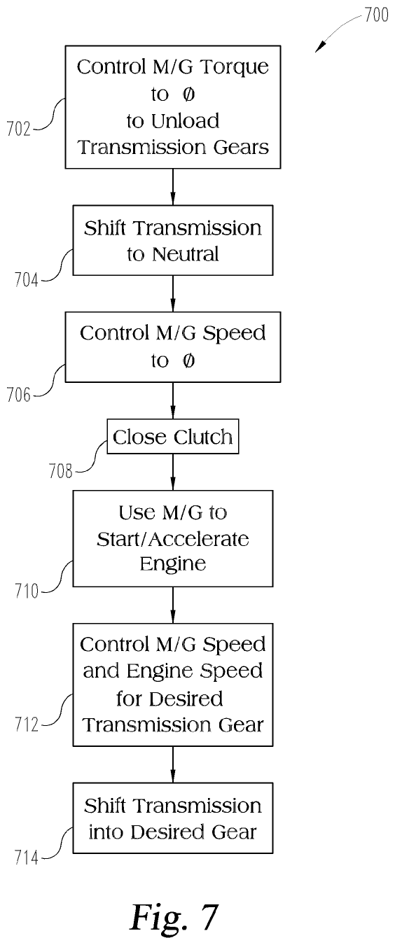

Referring to FIG. 7, a variation of method 600 is provided with reference to method 700. Method 700 begains at operation 702 to control the torque output of motor/generator 25 to zero to unload the transmission gears while the hybrid powertrain is operating in the first powertrain mode. Method 700 continues at operation 704 to shift the transmission 26 to neutral after unloading the gears. After shifting to neutral, the speed of motor/generator 25 is controlled to a zero (0) speed at operation 706.

Once the speed of motor/generator is zero, the positive clutch 34 is closed at operation 708. Motor/generator 25 can then be used to start and accelerate engine 32 at operation 710. At operation 712, the speed of motor/generator 25 and the speed of engine 32 are controlled for the desired transmission gear, and at operation 714 transmission 26 is shifted into the desired gear.

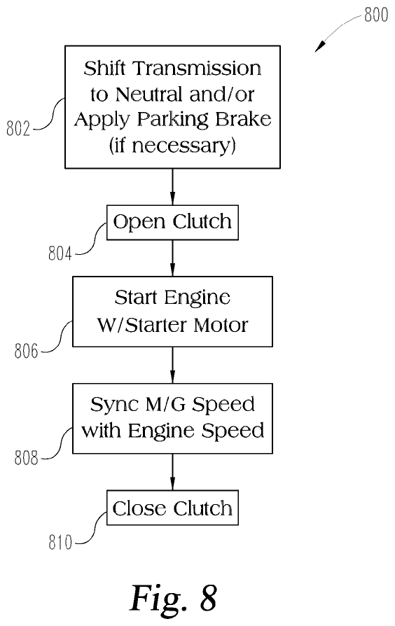

Another embodiment method 800 for starting engine 32 is provided in FIG. 8 while the vehicle 20 is stationary. Method 800 could be employed, for example, when operation of engine 32 is needed to power accessories or charge a battery of vehicle 20. Method 800 begins at operation 802. Operation 802 includes shifting transmission 26 into neutral and/or applying a parking brake, if necessary. Procedure 800 continues at operation 804 to open positive clutch 34 while the transmission 26 is in neutral and the parking brake is applied.

At operation 806, engine 32 is started with starter motor 39. The engine is fueled and the speed of engine 32 is then synced with the speed of motor/generator 25 at operation 808. Once the speeds are synced, positive clutch 34 is closed at operation 810. Engine 32 can then be used to power accessories and/or re-charge a battery of vehicle 20.

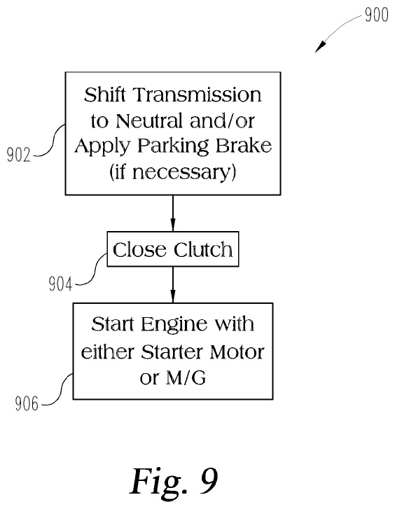

A variation of method 800 is provided in FIG. 9 with reference to method 900. Method 900 begins at operation 902. Operation 902 includes shifting transmission 26 into neutral and/or applying a parking brake, if necessary. Procedure 900 continues at operation 904 to close positive clutch 34 while the transmission is in neutral and the parking brake is applied.

Method 900 continues at operation 906 after closing positive clutch 34. The engine 32 can then be started at operation 906 with either starter motor 39 (if provided) or motor/generator 25. Starting engine 32 can include fueling engine 32 so that the accessories can be operated and/or battery re-charged.

As illustrated by the foregoing description, the present disclosure contemplates multiple aspects and embodiment including the following examples. It is contemplated, that one or more aspects and/or embodiments may be combined with one or more other aspects and/or embodiments.

A first aspect of the present disclosure is directed to a method of launching a vehicle including a hybrid powertrain. The method includes opening or maintaining open a positive clutch that is positioned between an engine and a drivetrain of the vehicle; propelling the vehicle with a motor/generator of the hybrid powertrain; synchronizing an output speed of the engine with an input speed of the drivetrain; and closing the positive clutch to connect the engine to the motor/generator when the output speed and the input speed are synchronized.

In an embodiment, the method includes starting the engine after propelling the vehicle with the motor/generator. In a further embodiment, starting the engine includes starting the engine with a starter motor.

In an embodiment, output speed and the input speed are synchronized when the output speed is within a predetermined threshold of the input speed. In an embodiment, propelling the vehicle includes propelling the vehicle after the engine is stopped. In an embodiment, propelling the vehicle includes propelling the vehicle from a stopped position.

Another aspect of the present disclosure is a method of launching a vehicle including a hybrid powertrain. The method includes closing or maintaining closed a positive clutch that is positioned between an engine and a drivetrain of the vehicle; propelling the vehicle with a motor/generator of the hybrid powertrain while rotating the engine with the motor/generator; and fueling the engine while accelerating the engine with the motor/generator.

In an embodiment, the method includes activating a cylinder decompression system associated one or more cylinders of the internal combustion engine while propelling the vehicle with the motor/generator. In a refinement of the embodiment, the method includes deactivating the cylinder decompression system after engine rotation with the motor/generator is initiated.

In an embodiment, the closed positive clutch is configured to prevent any slippage between an output shaft of the engine and an input shaft of the drivetrain. In an embodiment, the drivetrain includes an automated manual transmission. In an embodiment, the positive clutch is located between the engine and the motor/generator.

Another aspect of the present disclosure includes a method of operating a vehicle including a hybrid powertrain. The method includes propelling the vehicle with the hybrid powertrain. While a positive clutch is closed between an engine and a motor/generator of the powertrain, the method includes controlling an output torque of the engine and the motor/generator to unload a current gear of the transmission of the vehicle; shifting the unloaded transmission to a neutral gear; adjusting the output torque of the engine and the motor/generator to operate the engine and the motor/generator at a speed for a new gear of the transmission; and shifting the transmission into the new gear.

In an embodiment, the method includes adjusting the output torque from the engine and the motor/generator in response to a demanded torque after shifting the transmission into the new gear. In an embodiment, the positive clutch prevents slipping between the engine and the motor/generator.

In an embodiment, adjusting the output torque of the engine and the motor/generator includes lowering the speed of the engine and the motor/generator for the new gear of the transmission. In an embodiment, adjusting the output torque of the engine and the motor/generator includes increasing the speed of the engine and the motor/generator for the new gear of the transmission. In an embodiment, controlling the output torque of the engine and the motor/generator to unload the current gear including ramping the output torque to a net zero torque.

In another aspect of the present disclosure, a method of transitioning between operating modes of a vehicle including a hybrid powertrain includes: starting an engine of the hybrid powertrain while a positive clutch that is positioned between an engine and a motor/generator of the hybrid powertrain is open; synchronizing an output speed of the engine with an input speed of the drivetrain; and closing the positive clutch to connect the engine to the motor/generator when the output speed and the input speed are synchronized.

In another aspect of the present disclosure, a method of transitioning between operating modes of a vehicle including a hybrid powertrain includes: controlling an output torque of a motor/generator to unload a current gear of a transmission; shifting the transmission to a neutral gear; controlling the motor/generator to a zero speed; closing a positive clutch between the motor/generator and an engine of the hybrid powertrain; starting the engine of the hybrid powertrain with the motor/generator after closing the positive clutch; controlling an output speed of the engine and the motor/generator for engagement of a desired transmission gear; and shifting the transmission to the desired transmission gear.

In another aspect of the present disclosure, a method of starting an engine of hybrid powertrain for a stationary vehicle includes: shifting a transmission of the hybrid powertrain to a neutral gear and/or applying a parking brake; opening a positive clutch between the engine and a motor/generator of the hybrid powertrain; starting the engine with a starter motor; synchronizing an output speed of the engine with an input speed of the motor/generator; and closing the positive clutch to connect the engine to the motor/generator when the output speed and the input speed are synchronized.

In another aspect of the present disclosure, a method of starting an engine of hybrid powertrain for a stationary vehicle includes: shifting a transmission of the hybrid powertrain to a neutral gear and/or applying a parking brake; closing a positive clutch between the engine and a motor/generator of the hybrid powertrain; and starting the engine with a starter motor or the motor/generator.

In another aspect of the present disclosure, an electronic control system is configured to perform any of methods described herein.

In another aspect of the present disclosure, a system includes a hybrid powertrain with a positive clutch between an engine and a motor/generator. The system further includes an electronic control system configured to perform any of the methods described herein.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. It should be understood that while the use of words such as preferable, preferably, preferred, or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A method of launching a vehicle including a hybrid powertrain, the method comprising:
opening or maintaining open a positive clutch that is positioned between an engine and a drivetrain of the vehicle;
propelling the vehicle with a motor/generator of the hybrid powertrain;
synchronizing an output speed of the engine with an input speed of the drivetrain; and
closing the positive clutch to connect the engine to the motor/generator when the output speed and the input speed are synchronized.

2. The method of claim 1, further comprising starting the engine after propelling the vehicle with the motor/generator.

3. The method of claim 2, wherein starting the engine includes starting the engine with a starter motor.

4. The method of claim 1, wherein the output speed and the input speed are synchronized when the output speed is within a predetermined threshold of the input speed.

5. The method of claim 1, wherein propelling the vehicle includes propelling the vehicle after the engine is stopped.

6. The method of claim 1, wherein propelling the vehicle includes propelling the vehicle from a stopped position of the vehicle.

7. A method of launching a vehicle including a hybrid powertrain, the method comprising:
closing or maintaining closed a positive clutch that is positioned between an engine and a drivetrain of the vehicle;
propelling the vehicle with a motor/generator of the hybrid powertrain while rotating the Preliminary Amendment engine with the motor/generator; and
fueling the engine while accelerating the engine with the motor/generator.

8. The method of claim 7, further comprising activating a cylinder decompression system associated with one or more cylinders of the internal combustion engine while propelling the vehicle with the motor/generator.

9. The method of claim 8, further comprising deactivating the cylinder decompression system after engine rotation with the motor/generator is initiated.

10. The method of claim 7, wherein the closed positive clutch is configured to prevent any slippage between an output shaft of the engine and an input shaft of the drivetrain.

11. The method of claim 7, wherein the drivetrain includes an automated manual transmission.

12. The method of claim 7, wherein the positive clutch is located between the engine and the motor/generator.

13. A method of operating a vehicle including a hybrid powertrain, the method comprising:
propelling the vehicle with the hybrid power train, and while a positive clutch is closed between an engine and a motor/generator of the hybrid powertrain:
controlling an output torque of the engine and the motor/generator to unload a current gear of a transmission of the vehicle;
shifting the unloaded transmission to a neutral gear;
adjusting the output torque of the engine and the motor/generator to operate the engine and the motor/generator at a speed for a new gear of the transmission; and
shifting the transmission into the new gear.

14. The method of claim 13, further comprising adjusting the output torque from the engine and the motor/generator in response to a demanded torque after shifting the transmission into the new gear.

15. The method of claim 13, wherein the positive clutch prevents slipping between the engine and the motor/generator.

16. The method of claim 13, wherein adjusting the output torque of the engine and the motor/generator includes decreasing the speed of the engine and the motor/generator for the new gear of the transmission.

17. The method of claim 13, wherein adjusting the output torque of the engine and the motor/generator includes increasing the speed of the engine and the motor/generator for the new gear of the transmission.

18. The method of claim 13, wherein controlling the output torque of the engine and the motor/generator to unload the current gear includes ramping the output torque to a net zero torque.

19. The method of claim 13, further comprising transitioning between operating modes of the vehicle with the hybrid powertrain, the transitioning comprising:
starting the engine of the hybrid powertrain while the positive clutch that is positioned between the engine and the motor/generator of the hybrid powertrain is open;
synchronizing an output speed of the engine with an input speed of the drivetrain; and
closing the positive clutch to connect the engine to the motor/generator when the output speed and the input speed are synchronized.

20. The method of claim 13, further comprising transitioning between operating modes of the vehicle including the hybrid powertrain, the transitioning comprising:
controlling the output torque of the motor/generator to unload the current gear of the transmission;
shifting the transmission to the neutral gear;
controlling the motor/generator to a zero speed;
closing the positive clutch between the motor/generator and the engine of the hybrid powertrain;
starting the engine of the hybrid powertrain with the motor/generator after closing the positive clutch;
controlling an output speed of the engine and the motor/generator for engagement of a desired transmission gear; and
shifting the transmission to the desired transmission gear.

21-24. (canceled)
